(19) United States
(12) Patent Application Publication
(10) Pub. No.: US 2012/0099711 A1
(43) Pub. Date: Apr. 26, 2012

(54) TELECOMMUNICATION FRAUD PREVENTION SYSTEM AND METHOD

(76) Inventors: Liam Tully, Dublin (IE); Paul Byrne, Maynooth (IE)

(21) Appl. No.: 13/379,243

(22) PCT Filed: Jun. 25, 2010
(86) PCT No.: PCT/EP10/03825

§ 371 Date: Dec. 19, 2011

(30) Foreign Application Priority Data
Jun. 25, 2009 (EP) 09163745.4

(51) Int. Cl. H04M 3/22

(52) U.S. Cl. 379/32.01

(57) ABSTRACT

A system for monitoring of telephone calls on a plurality of inbound and outbound voice channels made to and originating from a common private branch exchange (PBX) to detect fraudulent activity. Monitors and detects audio data on two or more of the voice channels. Includes analysis of binary data streams on at least one inbound voice channel and at least one outbound voice channel and comparing said streams by a sliding window to slide a sample frame of one channel binary data stream backwards and/or forwards relative to the other binary data stream to synchronize the inbound voice channel and outbound voice channel. The comparison determines if a data match is present between the compared inbound channel and the outbound channel and blocks the at least one outbound voice channel, if a data match is found with at least one inbound voice channel.

### CROSS-REFERENCE TO RELATED APPLICATIONS

This application is a National Stage entry of International Application No. PCT/EP2010/003825 filed 25 Jun. 2010, which claims priority to European Patent Application EP 09163745.4, filed 25 Jun. 2009, the specification of which are both hereby incorporated herein by reference.

### FIELD OF THE INVENTION

The invention relates to fraud prevention for preventing fraudulent use of a telephone system. In particular the invention relates to a fraud prevention system in private branch exchange (PBX) systems.

### BACKGROUND TO THE INVENTION

The number of techniques that are used to perpetrate fraud in the Telecommunications industry continues to increase. The fraud can be as simple as using a stolen credit card to charge a long distance call, or it can involve sophisticated call looping techniques, such as repeatedly calling a private branch exchange (PBX), finding the correct sequence to access an outside line (by trial and error or other hacking techniques) and then placing a costly long distance call through the PBX system. Regardless of the type of fraud, the telecommunications industry is involved in an intensive and ongoing effort to identify different types of fraud and to develop and implement ways of preventing such fraud.

Particular methods of fraud control and systems for implementing them are known in the industry. Fraud control may be divided conceptually into identifying a call that is likely to be fraudulent and responding after a call is identified as likely to be fraudulent. Specifically, a fraud analyst uses billing detail records (BDRs) to validate call attempts in an effort to identify a fraudulent call and use call detail records (CDRs) in an effort to respond to fraud when a call has been completed. Methods of identifying calls that are likely to be fraudulent vary from the simple to the sophisticated and are generally directed at a particular type of fraudulent activity. For example, a call is likely to be fraudulent if it is made using a calling card that has been reported stolen by the owner. The BDRs and CDRs contain information pertaining to the calls. Each CDR and BDR contain an originating number (where the call is from), a terminating number (where the call is to), and a billing number (where the cost of the call is charged to).

PBX fraud or otherwise known as “Hacking” or “Dial Through” is on the rise. PBX fraud is rampant and growing in volume and sophistication. Organised criminals gain access through the PBX systems in order to resell long distance telephone calls at discounted rates or to generate high volumes of telephone calls to revenue sharing numbers i.e. 1550xxxxxx.

Exact figures for the extent of the problem are hard to come by, however quoted figures from the Irish Garda Bureau of Fraud Investigation state that in 2008 Irish firms were paying up to [symbol] 75 million a year for PBX fraud. Although the real figure for fraud is estimated to be much higher. In the UK, the reported annual figure is £1.3 billion. Global reports of PBX fraud estimate that the figure is greater than US$8 billion.

Despite the many security options associated with PBX systems plus the various 3^{rd} party reporting tools that integrate with PBX systems a continuous threat remains. Although these 3^{rd} party solutions will alert the administrator that the PBX was compromised, unfortunately it does so after the event. The 3^{rd} party solution is then dependent on the administrator receiving the alert so that he/she can act immediately to lock down the PBX and stop the fraudulent activity.

The various telecommunication carriers such as Eircom, BT, Verizon, etc witness the unusual calling patterns routing through their exchanges but tend not to notify the client. Generally speaking, the vast majority of clients become aware of the problem only when they receive their monthly phone bill at which point the financial impact is significant.

A system of detecting fraudulent calls made to a PBX is described in U.S. Pat. No. 5,805,686, entitled “Telephone Fraud Detection System”, assigned to Worldcom. The system disclosed in this US patent collects call details records (CDRs) and allows long distance phone customers the ability to monitor usage of their PBX and assign a risk factor to a plurality of recognized call types and destinations. Based upon the generated risk values, fraud analyst determines whether or not to block future access to the PBX for the originating, terminating, or billing number.

U.S. Pat. No. 5,504,810, Mcnair Bruce, discloses a system and method for providing increased security in a telecommunications network by using quasi-time domain reflectometry techniques to identify those telephone calls which comprise multiple legs. Echo data are collected for the telephone call from a predetermined point in the network to a point where the call originated. The data are processed to generate an indication of whether the telephone call comprises multiple legs, thus identifying those calls most susceptible to unauthorized use. The indication that a telephone call comprises multiple legs is advantageously used together with call attribute information, such as whether the call is placed to an international destination, to determine whether a given multiple-leg call is most likely a valid access to the communication system or most likely fraudulent.

US patent publication number US2004234056, Heilman et al, discloses a system and method of telephony resource management and security for monitoring and/or controlling and logging access between an enterprise's end-user stations and their respective circuits into the public switched telephone network (PSTN). One or more rules are defined which specify actions to be taken based upon at least one attribute of a call. Calls are detected and sensed to determine attributes associated with each call. Actions are then performed on selected calls based upon their attributes in accordance with the defined rules.

While these methods and systems are effective if a hacker makes many call attempts over a period of time, the systems may not detect hackers that break in to a PBX on one line, find an outside line with a different originating number, and call to another terminating number. Most fraud detection systems detect fraud by comparing either the originating numbers or the terminating numbers of the incoming call with the originating numbers or the terminating numbers of the outgoing call. If there are calls where the terminating number of the incoming call is the same as the originating number of the second call, the call may be a fraudulent call loop, and the call may be disconnected. Such products are dependent on client specific configurations plus manual intervention leaving the PBX vulnerable and at risk. If the administrator does not act immediately to a notification or if the hacker finds a route through the PBX that requires engineering skills to disable the port, the fraud will continue until the port is locked down. A further problem with PBX fraud is that it typically occurs over a weekend or at night when there is no administrator available.

The object of the invention is to provide a system and method for fraud prevention of a private branch exchange in a telecommunications network to overcome the above mentioned problems.

### SUMMARY OF THE INVENTION

According to the invention there is provided, as set out in the appended claims, a system for monitoring of telephone calls on a plurality of inbound and outbound voice channels made to and originating from a common private branch exchange (PBX) to detect fraudulent activity, said system comprising:
means for monitoring and detecting audio data on two or more of said voice channels; characterised in that: said detecting means comprises analysis of binary data streams on at least one inbound voice channel and at least one outbound voice channel and comparing said streams by a sliding window means to slide a sample frame of one channel binary data stream backwards and/or forwards relative to the other binary data stream to synchronise the inbound voice channel and outbound voice channel, said comparing determines if a data match is present between the compared inbound channel and the outbound channel; and
means for blocking the at least one outbound voice channel, if a data match is found with at least one inbound voice channel.

In one embodiment said binary data stream comprises a snapshot of audio data taken from at least one inbound voice channel and/or at least one outbound voice channel.

In one embodiment audio data snapshot comprises 22 bytes of binary information.

In one embodiment the sample frame comprises 3 bytes of binary data. It will be appreciated that any number of bytes can be used to implement the sliding window system according to the invention.

In one embodiment the sample frame is compared with the audio snap shot byte by byte until end of the audio snapshot.

In one embodiment said means for detecting comprises means for sending at least one audio probe at different frequencies across outbound voice channels; and means for scoping for the same frequencies coming back on inbound channels. Ideally said audio probe is inaudible to the human ear.

In one embodiment said detecting means comprises analysis of binary data streams on inbound and outbound channels and comparing said streams to determine if an energy match is present between an inbound channel and an outbound channel.

In one embodiment there is provided a sliding window means to slide a sample frame backwards and/or forwards to synchronise the inbound or outbound channel for comparing said binary streams, thereby eliminating any latency or time lapse between channels.

In one embodiment there is provided an automatic speech recognition (ASR) system for detecting the same voice energy on one or more of said voice channels.

In one embodiment said means for automatically monitoring comprises bridging ISDN circuits connected to said PBX and monitoring said voice energy associated with said ISDN circuits.

In one embodiment there is provided means for blocking the relevant outbound channels and alerting an administrator that there was an attempt to compromise the PBX, when said means for monitoring matches the same voice energy on an inbound and an outbound channel.

In one embodiment said means for detecting, blocking and alert the administrator is performed in real time.

In one embodiment said system comprises a firewall.

In a further embodiment of the present invention there is provided a method for monitoring of telephone calls on a plurality of inbound and outbound voice channels made to and originating from a common private branch exchange (PBX) to detect fraudulent activity, said system comprising the steps of:
monitoring and detecting audio data on two or more of said voice channels; characterised in that:
detecting binary data streams on at least one inbound voice channel and at least one outbound voice channel and comparing said streams by a sliding window means to slide a sample frame of one channel binary data stream backwards and/or forwards relative to the other binary data stream to synchronise the inbound voice channel and outbound voice channel, said comparing determines if a data match is present between the compared inbound channel and the outbound channel; and
blocking the at least one outbound voice channel, if a data match is found with at least one inbound voice channel.

There is also provided a computer program comprising program instructions for causing a computer program to carry out the method and control the system of the invention, which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates a block diagram of the system in operation according to the invention; and

FIG. 2 illustrates an implementation of the system according to the invention.

### DETAILED DESCRIPTION OF THE DRAWINGS

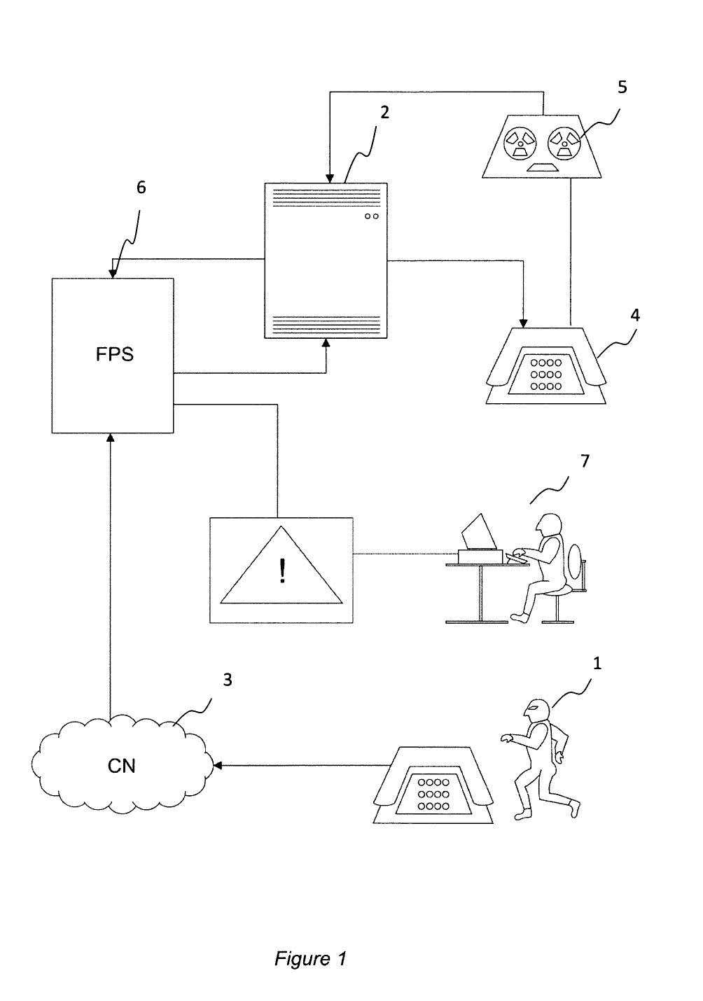

Referring now to FIG. 1 illustrates a phone hacker 1 attempting to hack into a PBX 2 via a carrier network (CN) 3. The phone hacker 1 identifies a Direct Dial-In (DDI) number 4 that routes in through the PBX 2, at this stage they will attempt to utilise functions within the PBX which allows them to dial back out of the PBX.

Arrows shows the hacker getting through the PBX 2 and into an extension users voice mail box 5. At this stage the hacker 1 can activate a function which allows them to make a fraudulent call. The system of the invention operates in the following manner.

A fraud prevention system 6 monitors telephone calls on a plurality of inbound and outbound voice channels made to and originating from a common private branch exchange (PBX) to detect fraudulent activity. The system provides for automatically monitoring and detecting the same audio data or voice energy on one or more of said voice channels. If an audio data or energy match is found with an inbound voice channel the invention provides for blocking an associated outbound voice channel.

In operation the detecting means comprises analysis of binary data streams on at least one inbound voice channel and at least one outbound voice channel by the system 6 and can be monitored by an administrator 7. The binary streams are compared by a sliding window means to slide a sample frame of one channel binary data stream backwards and/or forwards relative to the other binary data stream to synchronise the inbound voice channel and outbound voice channel. The comparing determines if a data match is present between the compared inbound channel and the outbound channel. An outbound channel can be blocked if an audio data match is found with at least one inbound voice channel.

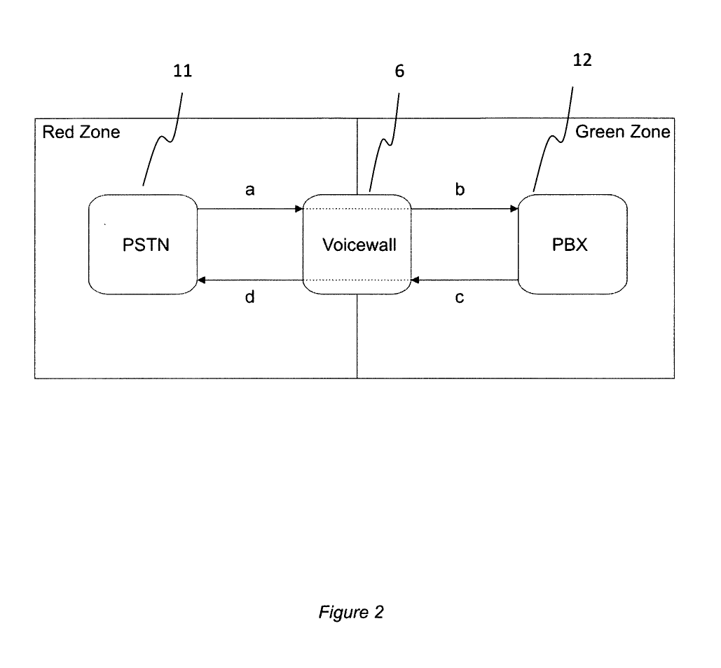

Referring now to FIG. 2 the sliding window technique is now described in more detail for the operation of the system 6. The sliding window technique works by comparing audio data from inbound calls to the audio data from outbound calls. FIG. 2 shows a PSTN 11 connected to a first (red) Zone of the system and a PBX 12 is connected to a second (green) Zone. The red zone represents inbound calls and the green zone represents outbound calls. The PSTN presentation method to the system or the systems presentation method to the PBX is irrelevant to the technique as the invention is only interested in audio channels.

FIG. 2 shows an example operation of a fraudulent call detection would be leg “a”, then “b”, then “c”, then finally “d”, where:
“a” is the PSTN presenting an inbound call
“b” is the system forwarding the call transparently to the PBX
“c” is the PBX making an outbound call
“d” is the system forwarding the call transparently to the PSTN
   after checking whitelist and blacklist
   after altering the Caller ID as per configuration.

The system 6 only has to monitor section “a” [Red Zone Inbound] and, section “c” [Green Zone Outbound] in operation. The Sliding Window technique operates when there is at least one call on leg “a” and at least one call on leg “c” as this is the only time a forwarded call can take place. Once this condition is met, a snapshot of audio is taken from each active channel and segregated into red zone channels and green zone channels. The system will compare every red zone channel inbound [leg a] against every green zone channel outbound [leg c], to detect fraudulent calls:
The first active Red Channel is compared against all active Green Channels.
The second active Red Channel is then compared against all active Green Channels
The third active Red Channel is then compared against all active Green Channels
And so on until the last active Red Channel is compared against all active Green Channels.

If a Red Channel is found to match a Green Channel, then both channels are logged [for example, to database, email, SMS, SNMP or other means] and disconnected. This information can be easily accessed by the administrator 7.

The actual Sliding Window is always taken from the current Red Channel being compared against all the Green Channels. The best way to describe the actual sliding window technique is by example. In the example below, there is one call on the Red Zone [leg a] and one call on the Green Zone [leg c]. For simplicity, the sliding window is set to three bytes in this example and an audio snapshot size of 22 bytes. It will be appreciated that any number of bytes can be used. The Sliding Window technique is a two stage process:
a. Find the Red Channel offset to a matched Green Channel by using one of the compare techniques mentioned below.
b. When the offset is found compare the rest of the two channels byte for byte using the offset as the beginning of the green channel audio snapshot and ignoring everything before the offset position in the green channel.

If no offset is found, then the channels don't match and the system restarts the routine.

An audio snapshot of 22 bytes can be taken from both calls.
1. The sliding window is generated by taking the first three bytes from the Red Zone call.
2. The sliding window is then compared with the first three bytes in the Green Zone call.
3. There is no match between the Red Zone three bytes and the Green Zone three bytes.

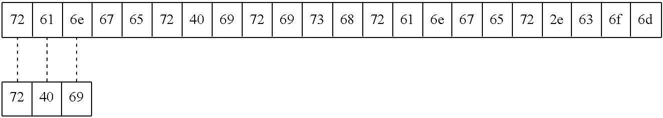

4. The sliding window is moved along the Green Zone call snapshot by one byte position.
5. The sliding window is then compared with those bytes.
6. There is no match between the Red Zone three bytes and the Green Zone three bytes.

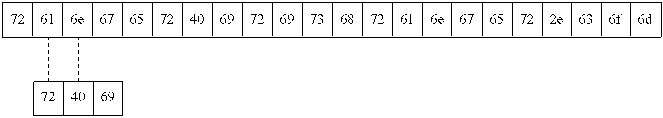

7. The sliding window is moved along by one more byte and compared again.
8. There is no match.

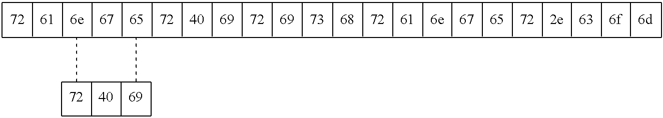

9. The sliding window is moved along by one more byte and compared again.
10. There is no match.

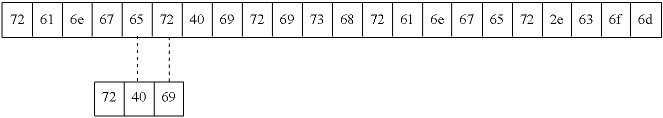

11. The sliding window is moved along by one more byte and compared again.
12. There is no match

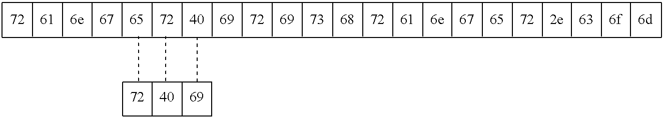

13. The sliding window is moved along by one more byte and compared again
14. This time, each three bytes on the Red Zone match the three bytes on the Green Zone call snapshot.
15. The Red Zone Channel offset has been found to be position 6.

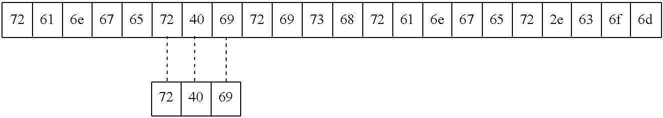

In the second step once the offset is found, both Red and Green zone snapshots are compared byte for byte. The red channel snapshot begins at the current position of the sliding window and the Green snapshot begins at the offset found [position 6 in this example]. Two implementations of this comparison would be, but not excluded to:
a. Byte by Byte values
b. Byte by Byte ratios [to combat different volumes on each zone]

### Byte by Byte Values

After matching up each snapshot, they are compared, byte by byte until the end of the snapshot. This is done by comparing Red[n] to Green[n] where [n] is the current byte position in the snapshot. A running count can be kept which denotes how many byte positions actually match. This count is then turned into a confidence percentage level by the following calculation:

Confidence Level %=(Total match Count/Total Byte count)*100

If the Confidence Level is greater than a pre configured level, for example 90%, the two snapshots are deemed to be identical.

### Byte by Byte Ratios

This technique is similar to the Byte by Byte values technique, described above, but rather than doing straight compares of the byte values, the following compare is done:

Ratio=Red[n]/Green[n]

This calculation is performed for every byte location and stored in a Hashtable [for example in C#]. The Hashtable item Key would be the ratio value. The Hashtable item value would be the count of every identical ratio value. To better explain this, consider the following pseudo code, based on C#, to obtain the ratio count:

//both Red[ ] and Green[ ] length are guaranteed unique
Hashtable Results = new Hashtable( );
for (int ArrayIndex = 0; ArrayIndex < Red.Length;
ArrayIndex++)

{
Ratio = Red[ArrayIndex] / Green[ArrayIndex];
if (Results.Contains(Ratio)) Results[Ratio] =

(int)(Results[Ratio]) + 1;

else Results[Ratio] = 1;

}

Once the ratio counts are collected, the following calculation is performed for each value in the Results Hashtable:

Value=(Results[n]/Green[ ]·Length)*100

The max Value for a given Results[x] is deemed to be the Confidence Level. If the Confidence Level is greater than a pre configured level, for example 90%, the two snapshots are deemed to be identical. Performing this Byte by Byte ratio technique takes into account the Red zone having a different volume level than the Green zone and is much more accurate than just comparing byte values.

It will be appreciated that regardless of the comparing technique used, there is still a chance of false positives. This can be minimized by also incorporating a number of methods. For example by allocating each channel a number of lives. Each time a channel confidence level is found to be greater than the threshold, a life is decremented. Only when a channel has no lives left is it deemed to be fraudulent and disconnected.

In another embodiment the means for monitoring and detecting can be provided by using an Audio Ping method involves sending out audio probes at different frequencies across active voice channels and scoping for the same frequencies coming back on different channels. The audio ping will ideally be inaudible to the human ear. The invention is designed to automatically monitor and detect the same voice energy on more than one DSP resources. If the system finds a match, the system will immediately block the associated B-Channel (or outbound channel) and alert the administrator to make them aware that the PBX was compromised. This can be implemented as a real-time process. In other words, if the system matches the same energy on the active DSP resources the system blocks the associated B-Channels and alerts the administrator.

It will be appreciated that the invention significantly reduces the risk of PBX fraud. In regard to fraudulent call activity been routed through a PBX, the system provides the ability to detect, block and alert an administrator in real time.

In another embodiment the monitoring and detecting the same voice energy on one or more of said voice channels can be implemented using a sliding window method that involves analysis of binary data streams on inbound and outbound channels and comparing these streams to identify matches. The voice energy is the audio data energy. The sliding window essentially means it is necessary to slide a sample frame backwards and/or forwards to synchronise it with either the inbound or outbound channel thereby eliminating any latency or time lapse between channels.

In a further embodiment the monitoring and detecting the same voice energy on one or more of said voice channels can be implemented using ASR (Automatic Speech Recognition) that involves matching voice patterns using a speech engine, for example a speech engine from Nuance.

The system to provide the means for automatically monitoring and detecting the same voice energy on one or more of said voice channels (described above) can be easily implemented in both hardware or software solution or a combination of both. In addition the means for blocking an associated outbound voice channel, if an energy match is found with an inbound voice channel can be implemented in both hardware or software or a combination of both.

It will be appreciated that the invention does not depend on integration to the PBX or assistance from an administrator to identify and stop a “Hacker”.

It will be appreciated that the system 6 of the invention can be implemented as a remote hosted solution such that all calls in a PBX are routed via the remote hosted system, for example over the internet or other communication network.

The present invention provides a real time solution that bridges the ISDN circuits that are connected to a PBX and by using intelligent monitoring software, such that the system can monitor the DSP resources associated with theses ISDN circuits. If system matches the same voice energy on more than one DSP resource, it will immediately block the relevant B-Channels and alert the administrator that there was an attempt to compromise the PBX.

It will be appreciated that the present invention operates continually and will automatically continue to detect and block the fraudulent call activity leaving an administrator 7 under no pressure to act immediately to an alert. All detections are immediately notified to the administrator 7, shown in FIG. 1, with an event log stored locally.

It will be appreciated that the system of the invention can be implemented in a firewall type solution that protects PBX systems (telephone systems) from criminals who are focused on hacking into a PBX for the purposes of generating profit by making long distance and premium rate telephone calls across the telephone lines that are connected to the PBX.

It will be appreciated that the system of the present invention will eliminate the following:—
Telecom carriers blaming the PBX provider for not protecting the PBX systems sufficiently.
Responsibility removed from the PBX providers should the PBX be compromised.
Telecom carriers will no longer witness the high levels of unusual calling activity routing through their exchanges.
No longer will the Telecommunication carriers enjoy the lucrative turnover and margins associated with PBX Fraud
Business community have the option to protect themselves from the significant financial impacts associated with PBX fraud.

In the context of the present invention the term ‘private branch exchange’ (PBX) is a telephone exchange that serves a particular business or office or telephone company that can operate for many businesses or for the general public and should be afforded a broad interpretation. PBXs can also be referred to as private automatic branch exchange (PABX) or electronic private automatic branch exchange (EPAX).

The embodiments in the fraud prevention system and method described with reference to the drawings comprise a computer apparatus and/or processes performed in a computer apparatus. However, the invention also extends to computer programs, particularly computer programs stored on or in a carrier adapted to bring the fraud prevention system of the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

While the invention has been described herein with reference to several especially preferred embodiments, these embodiments have been presented by way of example only, and not to limit the scope of the invention. Additional embodiments thereof will be obvious to those skilled in the art having the benefit of this detailed description, especially to meet specific requirements or conditions. Further modifications are also possible in alternative embodiments without departing from the inventive concept.

The invention is not limited to the embodiments hereinbefore described but may be varied in both construction and detail.

What is claimed is:

1-16. (canceled)

17. A system configured to monitor telephone calls on a plurality of inbound and outbound voice channels made to and originating from a private branch exchange or PBX network to detect fraudulent activity, said system comprising:
a computer configured to
monitor audio data on two or more of said voice channels;
analyze binary data streams on at least one inbound voice channel and at least one outbound voice channel through a compare of said binary data streams with a sliding window to slide a sample frame of one binary data stream backwards and/or forwards relative to another binary data stream to synchronize the inbound voice channel and the outbound voice channel;
determine if a data match is present between the at least one inbound voice channel and the at least one outbound voice channel; and
block the at least one outbound voice channel, if a data match is found with at least one inbound voice channel.

18. The system of claim 17 wherein said binary data streams comprise a snapshot of audio data taken from the at least one inbound voice channel and/or the at least one outbound voice channel.

19. The system as claimed in claim 18 wherein the audio data snapshot comprises 22 bytes of binary information.

20. The system as claimed in claim 17 wherein the sample frame comprises 3 bytes of binary data.

21. The system as claimed in claim 18 wherein the sample frame is compared with the snapshot of audio data byte by byte until an end of the snapshot of audio data.

22. The system as claimed in claim 17 wherein said computer is further configured to send at least one audio probe at different frequencies across said at least one outbound voice channel; and,
scope for said different frequencies coming back on said at least one inbound voice channel.

23. The system of claim 22 wherein said at least one audio probe is inaudible to a human ear.

24. The system of claim 17 further comprising an automatic speech recognition or ASR system configured to detect an audio data match on said two or more of said voice channels.

25. The system of claim 17 wherein said computer is further configured to bridge ISDN circuits connected to said PBX to monitor voice energy associated with said ISDN circuits.

26. The system of claim 17 wherein said computer is further configured to alert an administrator that there was an attempt to compromise the PBX, when said data match is found.

27. The system as claimed in claim 26 wherein said compare, block and alert of the administrator is performed in real time.

28. The system of claim 17 further comprising a firewall.

29. A method for monitoring of telephone calls on a plurality of inbound and outbound voice channels made to and originating from a common private branch exchange or PBX to detect fraudulent activity, said system comprising the steps of:
monitoring audio data on two or more of said voice channels;
analyzing binary data streams on at least one inbound voice channel and at least one outbound voice channel through comparing of said binary data streams with a sliding window to slide a sample frame of one binary data stream backwards and/or forwards relative to another binary data stream to synchronize the inbound voice channel and the outbound voice channel;
determining if a data match is present between the at least one inbound voice channel and the at least one outbound voice channel; and
blocking the at least one outbound voice channel, if a data match is found with at least one inbound voice channel.

30. The method of claim 29 comprising using an automatic speech recognition or ASR system in detecting an audio data match on said two or more of said voice channels.

31. The method as claimed in claim 29 further alerting an administrator that there was an attempt to compromise the PBX, when said data match is found.

32. The method as claimed in claim 29 further comprising utilizing a computer comprising program instructions wherein said program instructions configure said computer to perform said monitoring, said detecting and said blocking.
